(19) United States
(12) Patent Application Publication
(10) Pub. No.: US 2011/0091644 A1
(43) Pub. Date: Apr. 21, 2011

(54) Water release silver and holographic metal flake and method of manufacturing metal flake

(75) Inventors: Kurt B. Gundlach, Warren, MA (US); Thomas R. Fields, Milford, MA (US)

(73) Assignee: Vacumet Corp.

(21) Appl. No.: 12/589,028

(22) Filed: Oct. 16, 2009

(51) Int. Cl. B05D 5/00; B05D 3/00; B05D 3/12; B32B 15/04; B32B 15/08; B32B 3/30

(52) U.S. Cl. 427/177; 427/294; 427/271; 427/270; 428/457; 428/458; 428/172

(57) ABSTRACT

A metal flake film assembly comprising a base film having a first side and a second side. A coating is positioned on the first side of the base film. The coating is one of a water soluble polymer or a water dispersible polymer with a predetermined content of a water soluble polymer which coats and adheres to the base film. A metal layer is vacuum deposited upon the coating. The coating may be embossed. A method of manufacture of metal flakes is likewise disclosed.

### BACKGROUND OF THE DISCLOSURE

1. Field of the Disclosure

The disclosure relates in general to the formation of metal flakes, and more particularly, to the formation of metal flakes using water soluble coatings.

2. Background Art

The use of metal flakes in various products has been known for a number of years. The metal flakes, typically having size ranges between 5 microns and 200 microns are utilized in metallic paints (for automotive applications, for example), as well as in applications in the cosmetics industry (nail polish, for example) as well as in metallic inks. Such metal flakes can be created in a number of different manners.

One typical method of manufacture is to provide a solvent based system wherein a base film is provided and coated with a polymer that will dissolve in an organic based solvent. A metallized layer is then vacuum deposited upon the coating. Finally, the film assembly is introduced into a solvent bath wherein the coating is dissolved releasing the deposited metal in flake size particles.

Typically, such systems utilize harsh chemicals, such as warm ethyl acetate solvent. These solvents are difficult to handle and often require extensive safety measures to handle in a safe manner. In addition, these chemicals are classified as hazardous waste and are not easily recycled or disposed of.

Water based release coatings have been contemplated, however, it has proven difficult to develop water based release coatings that are acceptable for creating metal flakes with the appropriate performance. Many water based release coatings are incapable of receiving micro embossings and retaining the micro embossings through further processing and metallization. Other water based release coatings are incapable of providing flakes of the appropriate size and shape. Still others have compatibility problems with suitable underlying base films.

It is an object of the present invention to provide a water based release coatings for use in the production of metal flakes.

This object as well as other objects of the present invention will become apparent in light of the present specification, claims, and drawings.

### SUMMARY OF THE DISCLOSURE

The disclosure is directed to metal flake manufacture and film assemblies from which metal flake can be manufactured.

Specifically, with respect to metal flake manufacture, it is contemplated that, in a preferred embodiment, metal flake can be manufactured by providing a base film having a first side and a second side. Next, a coating is applied to the first side of the base film layer. The coating comprises a film forming water soluble or water dispersible polymer that does not block or transfer from the base film when wound into a roll, accepts metal deposition onto its surface, and can be removed in an aqueous solution after metal deposition to generate metal flakes. Once applied, the coating is dried. After drying of the coating, a layer of metal is vacuum deposited on the coating. Once the film assembly is manufactured, the film assembly can be stored or transported until metal flake is needed. To form the metal flakes, the coating is dissolved from the base film layer so as to render metal flakes.

In a preferred embodiment for the formation of silver metal flakes, the coating comprises a partially hydrolyzed polyvinyl acetate, polyvinyl alcohol, or a polyvinyl pyrrolidone, or combinations thereof.

In another preferred embodiment, the coating comprises a water dispersible polymer that coalesces during drying and a predetermined amount of a water soluble polymer, including but not limited to, polyvinyl pyrrolidone or partially hydrolyzed polyvinyl acetate.

In another preferred embodiment, the method further contemplates micro embossing the coating after drying the coating. In such an embodiment, the coating is thermoplastic such that it is structurally configured to accept micro-embossings through the application of heat and pressure by a roller, and to retain the micro-embossing.

In yet another preferred embodiment, a two sided film assembly can be provided. Specifically, a coating can be applied to the second side of the base film after vacuum depositing metal on the first side. Next, the coating can be dried. Once dried, metal can be vacuum deposited on the coating on the second side.

In one such preferred embodiment, the method may further contemplate the steps of micro embossing the coating applied to the first side of the base film after the step of drying the coating applied to the first side of the coating; and micro embossing the coating applied to the second side of the base film after the step of drying the coating applied to the second side of the coating.

In another aspect, the disclosure comprises a metal flake film assembly. The film assembly includes a base film, a coating and vacuum deposited metal layer on the coating. The base film has a first side and a second side. The coating is positioned on the first side of the base film, and, the coating comprising a film forming water soluble or water dispersible polymer that does not block or transfer from the base film when wound into a roll, accepts metal deposition onto its surface, and can be removed in an aqueous solution after metal deposition to generate metal flakes. The metal layer is applied to the coating.

In a preferred embodiment, the coating comprises a film forming water soluble or water dispersible polymer that does not block or transfer from the base film when wound into a roll, accepts metal deposition onto its surface, and can be removed in an aqueous solution after metal deposition to generate metal flakes.

In another preferred embodiment, the base film comprises a PET material.

Preferably, the PET material comprises a non corona treated PET material.

In a preferred embodiment, a micro embossing is impressioned on the coating.

In another preferred embodiment, a coating is positioned on the second side of the base film, the coating comprising a water soluble polymer.

Preferably, a micro embossing is impressioned on the coating positioned on the second side of the base film.

### BRIEF DESCRIPTION OF THE DRAWINGS

The disclosure will now be described with reference to the drawings wherein:

FIG. 1 of the drawings is a cross-sectional view of a first embodiment of the film assembly of the present invention;

FIG. 2 of the drawings is a cross-sectional view of a second embodiment of the film assembly of the present invention;

FIG. 3 of the drawings is a cross-sectional view of a third embodiment of the film assembly of the present invention;

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

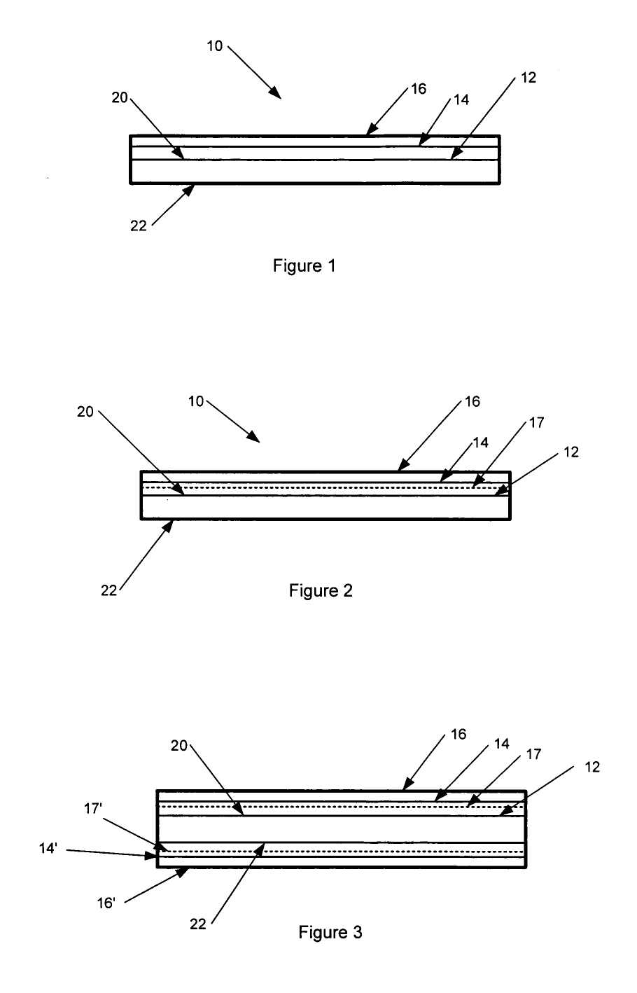

Referring now to the drawings and in particular to FIG. 1, a metal flake film assembly is shown generally at 10. The metal flake film assembly is used to create metal flakes of the type that are incorporated into various different products, such as automotive paints, nail polishes and the like. Of course, the disclosure and the metal flakes described herein are not limited to use in any particular application, and, any application is described for exemplary purposes solely without limitation.

The metal flake assembly 10 is shown in FIG. 1 as comprising a base film 12, coating 14 and vacuum deposited metal layer 16. The base film comprises a polymer base film having a first surface 20 and a second surface 22. The polymer base film can withstand the temperatures at which the coating is dried and the temperature of which any embossing (if any) is applied to the coating. In the embodiments contemplated, a PET material, which may or may not be treated (i.e., corona treated) is contemplated. Of course, other polymers are likewise contemplated.

The coating 14 comprises a film forming coating that is either a water soluble polymer or a water dispersible with a predetermined content of a water soluble polymer which coats and adheres to the base film. The coating forms a film on the base film and adheres to the base film. Such adhesion remains even after the coating is dried and the base film with coating is wound up into a roll of film.

In some embodiments, the coating comprises a partially hydrolyzed polyvinyl acetate or a polyvinyl pyrrolidone, or combinations thereof, or a water dispersible polymer having a predetermined content of a water soluble polymer at approximately 4% by weight or more. It will be understood that when micro-embossed, the water based polymer is structurally configured to accept and retain micro-embossings that are transferred to the coating through temperature and pressure. Additionally, the structural integrity of the coating remains after micro-embossing and winding up of the base film on a roll. The coating can be applied in two layers, wherein the first coating layer smoothes out the underlying surface variations in the film, and the second layer provides a smooth surface upon which vacuum metallization can be deposited.

The vacuum deposited metal layer 16 is shown in FIG. 1 as comprising a vacuum deposited aluminum layer. The layer generally has an optical density of between 1 and 4, although other optical densities of the layer are likewise contemplated. Of course, other materials, such as indium, gold and other metals and alloys thereof are fully contemplated.

In the embodiment of FIG. 2, a micro embossing 17 can be impressed upon the coating so that a diffraction grading can be created (i.e., a holographic image). The micro embossing is impressed upon the coating prior to vacuum metallization of the metal thereon. The coatings described above have been found to be suitable for receiving micro embossings and for maintaining the micro embossings throughout the vacuum metallization process.

In another embodiment, with reference to FIG. 3, both sides of the base material can be coated with the coating (in one, as shown, or in multiple layers). It will be understood that the corresponding structures on the second side of the base material have like reference numbers augmented by a prime (′). The sides can be done sequentially. The first side is coated and then metallized. Subsequently, the second side is coated then metallized. Additionally, it will be understood that, as shown in FIG. 3, the coatings on either side can be micro embossed with micro embossings 17, 17′ prior to metallization (or they may be free of any micro embossing). In addition, it will be understood that, although not shown in the drawing, multiple layers can be placed so that a single film may include several metallized layers (micro embossed or not micro embossed as desired). Such a configuration is shown in copending patent application entitled “Multi-layer metal flake film assembly” assigned to the same assignee as the present application. The entire specification of the copending application is hereby incorporated by reference in its entirety.

To manufacture the metal flake assembly of the embodiment shown in FIG. 1, the base film is provided. The base film is then coated with the water soluble coating. Typically, the coatings are applied in solution and then run through a heating chamber to evacuate the solvent (in this case an aqueous solution). As identified above, it has been found that a suitable coating comprises a partially hydrolyzed polyvinyl acetate or a polyvinyl pyrrolidone, or combinations thereof, or a water dispersible polymer having a predetermined content of a water soluble polymer at approximately 4% by weight or more.

Once the material is coated with the coating and the coating has been dried, the film can be processed through a vacuum metal deposition station. In such a station, metal, such as aluminum, can be vacuum deposited upon the underlying base film. Such processes are well known in the art of vacuum metal deposition. The result is that a thin layer of metal is deposited on the coating.

Once the film has been metallized, then, the metal flake assembly is completed and ready for use. Typically, to render metal flakes from such a metal flake assembly, the user processes the film through an aqueous solution. The aqueous solution dissolves the underlying coating, or a portion thereof (in the case of a dispersion) that is between the base film and the metallized layer. The resulting metallized layer separates from the coating and the film as it is dissolved. Due to the vacuum deposition process and the manner in which the metallized particles form on the coating, the metallized layer separates in small flakes. The size and shape of the different flakes can be controlled by controlling various properties of the vacuum metallization process. For example, the time and the optical density of the metallized layer can be varied to vary the size of any resulting metal flakes.

The solubility of the polymer is such that, typically, agitation of the film is not required, simply placing the film in a solution will dissolve the coating and release the metal flakes from the underlying film. In other embodiments, some agitation may be required to increase the rate at which the metal flakes separate.

Once separated, the metal flakes can be further processed to remove remaining solvent. For example, the metal flakes can be introduced into further aqueous solutions to assist with the dissolving of any coatings that may have remained on the metal flakes.

In another embodiment, after the coating has been applied and dried, the coating can be micro embossed so as to render a diffraction grating. Typically, the coated film is processed through a roller that includes a micro embossed shim. The coating is softened through heating and the micro embossing is transferred by applying the shim to the film and coating under pressure. Typically, the processing temperatures of the embossing step is between 130° C. and 200° C. Once the micro embossing is impressed upon the coating, the film can be processed through the metallization station as with film that is not micro embossed.

A sample was prepared for a coating comprising a polyvinyl alcohol which was 75% hydrolyzed (having a MW of approximately 2000 gm/mol), a poly diallyldimethylammonium chloride at 20% wt in water. Such a formulation was coated on a Nanya 1.4% haze 48 gauge NON-Corona side PET. The coated film was then embossed with a micro embossing. Subsequently, the micro embossed film with the coating was then metallized. The metallized film was then placed in water. The release time was approximately 8 seconds with a swirl. It was observed flakes had a good rainbow appearance.

Certain test examples were created following the disclosure and the methods disclosed therein. Each example is set forth below in detail. It will be understood that these are merely exemplary of the embodiments of the disclosure, and are not to be deemed limiting.

### Example 1

A base film was provided in the form of a NanYa BH216 polyester film that was corona treated. The base film was coated with an aqueous solution of Elvanol 51-03 L24 available from DuPont at 15.2% solid content by weight. The film and coating were dried at 70° C. for one minute in a forced air oven to a coating weight of 1 gsm. The coating was embossed in a micro-embossing step at 180° F. to yield a moderately bright image. The embossed coating was then lab metallized to an optical density of between 1.5-2.0.

Flakes were produced by placing a 4″×4″ sample of the resulting metallized film in an 11 dram vial. Next, 15 ml of water were added to the vial and the vial was manually shaken for a period of 10 seconds. The metal was completely removed from the polyester film in flakes. High quality embossed metal flakes were generated by the process.

### Example 2

A base film was provided in the form of a NanYa BH216 polyester film which was corona treated. Next, the base film was coated with an aqueous solution of Jarpol PVP K-30 from Jarchem Industries at 21% solid by weight. The film and coating were dried at 70° C. for one minute in a forced air oven to a coating weight of 1 gsm. The coating was then lab metallized to an optical density of 1.5-2.0.

Flakes were produced by placing a 4″×4″ sample of this metallized film in an 11 dram vial. Next, 15 ml of water was added to the vial and the vial was shaken by hand for a period of 10 seconds. The metal was completely removed from the polyester film in large flakes. It was noted that this coating did not appear to be embossable at a temperature of up to 180° C.

### Example 3

A base film was provided in the form of a 48 gauge NanYa BH216 polyester film, which was corona treated. Next, an aqueous dispersion of a styrene acrylic polymer from Cork Industries (product number, FP-3122 ND) was diluted 2:1 with water, and coated onto the base film. The film and coating were then dried at 70° C. for one minute in a forced air oven to a coating weight of 1 gsm. The coating was lab metallized to an optical density of 1.5-2.0.

A 4″×4″ sample of this metallized film in an 11 dram vial. Next, 15 ml of water was added to the vial and the vial was manually shaken for 120 seconds. The coating was not dissolved nor otherwise separated from the base film or the metallized layer and integrity of the sample was maintained throughout.

### Example 4

Utilizing the formula of Example 3, a 5% formula weight of Luvitec PVP K30 from BASF was added to the coating solution. This solution was coated to 1 gsm on the same film as that which was used in Example 3. The coating was lab metallized to an optical density of 1.5-2.0.

This time, flakes were made by placing a 4″×4″ sample of the metallized film in an 11 dram vial. Next 15 ml of water was added to the vial and the vial was shaken by hand for 30 seconds. Within the 30 seconds, all of the metal was removed from the film as flakes.

### Example 5

A base film was provided in the form of a NanYa BH216 polyester film, which was corona treated. Next, an aqueous solution of 12.5 parts NeoCryl BT-67 from DSM Neoresins, 7.2 parts of Water Based Urethane 30522 from Raffi & Swanson, and 8.9 parts water was coated onto the base film. The base film and coating were dried at 70° C. for one minute in a forced air oven to a coating weight of 1 gsm. This coating was embossed at 160° F. to yield a bright Rainbow holographic image. Next, the embossed coating was lab metallized to an optical density of 1.5-2.0.

Next, a 4″×4″ sample of the resulting metallized film was place in an 11 dram vial. Subsequently, 15 ml of water was added to the vial and the vial was manually shaken for 120 seconds. The coating was not dissolved nor otherwise separated from the base film or the metallized layer and integrity of the sample was maintained throughout.

### Example 6

Utilizing the formula of Example 5, a 5% formula weight of Jarpol PVP K-30 from Jarchem Industries was added to the coating solution. The coating solution was then applied to the same base film. The film was again dried at 70° C. for one minute in a forced air oven to a coating weight of 1 gsm. The coating was metallized to an optical density of 1.5-2.0.

This time, flakes were made by placing a 4″×4″ sample of the metallized film 6 in an 11 dram vial. Next 15 ml of water was added to the vial and the vial was shaken by hand for 10 seconds. Within the 10 seconds, all of the metal was removed from the film as flakes.

### Example 7

A base film was provided in the form of a NanYa BH216 polyester film which was corona treated. Next, Luvitec VPC 55 K 65 W (copolymer of 1-vinyl-2-pyrrolidone and vinyl caprolactam available from BASF) was dissolved in water at 15% by weight. The resulting aqueous solution was coated onto the base film. The film and coating were then dried at 70° C. for one minute in a forced air oven to a coating weight of 1 gsm. Next, the coating was lab metallized to an optical density of 1.5-2.0.

Flakes were made by placing a 4″×4″ sample of the metallized film in an 11 dram vial. Next 15 ml of water was added to the vial and the vial was shaken by hand for 30 seconds. Within the 30 seconds, all of the metal was removed from the film as flakes.

Advantageously, the use of an aqueous solution provides metal flakes that are highly suitable for their intended use without the use of harsh chemicals, to, in turn, render a more environmentally friendly process.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method of manufacturing metal flake comprising the steps of:
providing a base film having a first side and a second side;
applying a film forming coating to the first side of the base film layer, the coating comprises one of a water soluble polymer or a water dispersible polymer with a predetermined content of a water soluble polymer which coats and adheres to the base film;
drying the coating;
vacuum depositing a layer of metal upon the coating; and
dissolving the coating from the base film layer so as to render metal flakes.

2. The method of manufacturing metal flake according to claim 1 wherein the coating comprises a partially hydrolyzed polyvinyl acetate or a polyvinyl pyrrolidone, or combinations thereof, or a water dispersible polymer having a predetermined content of a water soluble polymer at approximately 4% by weight or more.

3. The method of manufacturing metal flake according to claim 1 further comprising the steps of:
micro embossing the coating after the step of drying the coating.

4. The method of manufacturing metal flake according to claim 1 further comprising the steps of:
applying a coating to the second side of the base film after the step of vacuum depositing;
drying the coating applied to the second side of the base film; and
vacuum depositing a second layer of metal upon the coating applied to the second side of the base film layer.

5. The method of manufacturing metal flake according to claim 4 further comprising the steps of:
micro embossing the coating applied to the first side of the base film after the step of drying the coating applied to the first side of the coating; and
micro embossing the coating applied to the second side of the base film after the step of drying the coating applied to the second side of the coating.

6. The method of manufacturing metal flake according to claim 4 further comprising the step of:
rolling the base film after the step of drying the coating; and
unrolling the base film prior to the step of vacuum depositing metal.

7. The method of manufacturing metal flake according to claim 6 further comprising the step of:
rolling the base film after the step of vacuum depositing metal.

8. A metal flake film assembly comprising:
a base film having a first side and a second side;
a film forming coating positioned on the first side of the base film, the coating comprising a water soluble polymer or a water dispersible polymer with a predetermined content of a water soluble polymer which coats and adheres to the base film; and
a vacuum deposited metal layer applied to the coating.

9. The metal flake forming assembly of claim 8 wherein the coating comprises a partially hydrolyzed polyvinyl acetate or a polyvinyl pyrrolidone, or combinations thereof, or a water dispersible polymer having a predetermined content of a water soluble polymer at approximately 4% by weight or more.

10. The metal flake forming assembly of claim 8 wherein the base film comprises a PET material.

11. The metal flake forming assembly of claim 10 wherein the PET material comprises a non corona treated PET material.

12. The metal flake forming assembly of claim 8 further comprising a micro embossing impressioned on the coating.

13. The metal flake forming assembly of claim 8 further comprising a coating positioned on the second side of the base film, the coating comprising a water soluble polymer.

14. The metal flake forming assembly of claim 13 further comprising a micro embossing impressioned on the coating positioned on the second side of the base film.

15. The metal flake forming assembly of claim 14 further comprising a micro embossing impressioned on the coating positioned on the first side of the base film.
